(19) United States
(12) Patent Application Publication
(10) Pub. No.: US 2009/0219623 A1
(43) Pub. Date: Sep. 3, 2009

(54) Negative Index Material With Compensated Losses

(76) Inventors: Vladimir M. Shalaev, West Lafayette, IN (US); Vladimir P. Drachev, West Lafayette, IN (US); Thomas A. Klar, Erfurt (DE); Alexander V. Kildishev, West Lafayette, IN (US)

Correspondence Address: COLEMAN SUDOL SAPONE, P.C., 714 COLORADO AVENUE, BRIDGE PORT, CT, 06605-1601, US

(21) Appl. No.: 12/224,196

(22) PCT Filed: Feb. 28, 2007
(86) PCT No.: PCT/US2007/005152

§ 371 Date: Nov. 3, 2008

Related U.S. Application Data
(60) Provisional application No. 60/777,873, filed on Mar. 1, 2006.

(51) Int. Cl. G02B 1/00; G02B 3/00

(52) U.S. Cl. 359/642

(57) ABSTRACT

A composition of resonant passive metal-dielectric elements with gain medium results in a meta-material with an effective negative refractive index and compensated losses. To compensate for losses, additional energy is supplied using the stimulated emission from active elements made of a gain material. The overall objective is to overcome the fundamental threshold in resolution for conventional optical imaging limited to about a half-wavelength of incident light. The negative index material with compensated losses (NIMCOL) can be used in NIM-based optical imaging and sensing devices with enhanced sub-wavelength resolution. A lasing device based on overcompensating for the loss in NIM structures is disclosed as well.

### BACKGROUND

The invention deals with a new composition of resonant passive metal-dielectric elements with a gain medium resulting in a metamaterial with an effective negative refractive index and compensated losses. The invention is pertinent to negative index material with compensated losses (NIMCOL) and NIM-based optical imaging and sensing devices with enhanced sub-wavelength resolution.

Conventional optical imaging has a spatial resolution of about a half-wavelength (i.e., approximately about 200-400 nm) in the visible range, governed by the diffraction limit, and the spatial resolution is even worse for IR imaging because of the longer wavelengths. Known resonant metal-dielectric NIMs could provide sub-wavelength resolution far beyond the diffraction limit, but absorptive losses in resonant elements of the NIMs are among the most important intrinsic limitations of their performance. The proposed NIMCOLs compensate for losses with amplification provided by the stimulated emission from gain inclusions and keep the transmission up at practical levels.

An alternative approach to high-resolution imaging is to use evanescent scattered modes with the near-field scanning optical microscopy (NSOM). NSOM employs an optical fiber tip with a small aperture to deliver laser radiation and/or to collect the scattered light. The main reason for the restricted use of NSOM originates from the facts that (i) NSOM apparatus is an expensive complex of opto-mechanical devices, and (ii) a fiber based delivery or collection is a time-consuming process resulting from the mechanically driven slow scanning procedure itself.

An alternative approach is to use a flat near-field NIM lens consisting of uniform layers of thin metal films separated by thin uniform dielectric layers. However, the enhancement of resolution in this case is restricted by the lack of a negative magnetic response for a non-resonant multilayer structure used in this approach. This relatively low focusing enhancement can also occur only within a narrow distance range and thus, similar to NSOM, using non-resonant near-field regimes of metal-dielectric composites can not provide far-field imaging.

Pendry and coworkers have suggested “. . . a compensation for the losses by introducing optical gain media into the [NIM] lens design”. ([20], abstract) In the Pendry paper, the losses in NIM lenses are compensated in a layered structure, where lossy (n [symbol] >0) layers of NIM (n¢0) materials are interleaved with gain layers of positive refractive index (n [symbol] <0,n¢0). In another work, Pendry together with Smith, Schultz and others states more generally the following: “Negative refractive indices have been demonstrated in structured metamaterials, and such materials can be engineered to have tunable material parameters so as to achieve optimal conditions. Losses can be minimized in structures utilizing superconducting or active elements”. ([21], last two sentences). This very general statement is not backed with any precise information by Smith et al. that can lead to working devices.

The first conceptual design of a magnetically active metamaterial arranged of two split ring resonantors (SRRs) of subwavelength dimensions was predicted to give μ′<0 [1]. The SRRs have been further combined with metallic wires with a negative electric response in the 10 GHz range [2]. The outcome was the first-ever NIM with ε′<0 and μ′<0 at ˜10 GHz[3]. Further downsizing led to higher frequency responses, and the resonance was pushed up to 1THz [4]. An alternative to double SRRs is a single SRR facing a metallic mirror, where the resonance frequency was shifted to 50 THz [5]. But further downscaling becomes uncertain due to localized plasmonic effects, which nonetheless open yet another design opportunities. Thus, a double SRR is not required any more [6]. The electric resonance of single SRRs has even been pushed to the important telecom wavelength of 1.5 μm [7] and it was concluded that the magnetic response of single SRRs should be found at the same frequency [8]. In [9], it was shown experimentally that a sample containing pairs of gold nanopillars show transmission spectra that can be explained if a negative permeability is assumed. However, an experimental proof of a negative refractive index was not given in that work.

The unambiguous measurement of a negative refractive index in the optical range (specifically, at the optical telecom wavelength of 1.5 μm) was reported in [11] and predicted in [10]. Pairs of nanorods were fabricated on a glass substrate using electron beam lithography. A full description of the sample and its preparation is given in [12, 13]. According to experimental and simulation results obtained in [11] for our NIM, the refractive index becomes negative in the wavelength range from approximately 1400 nm to 1600 nm, which includes the important telecommunication band at 1500 nm. The experimental data proving that n′=−0.3±0.1 has been obtained.

A negative refractive index has been also obtained for the inverted system of paired dielectric voids in a metal [14,15]. We note that inverted NIMs, i.e. elliptical or rectangular dielectric voids in metal films, are physically equivalent to paired metal rods in a dielectric host, in accordance with the Babinet principle. The idea to use gain media to offset losses in propagating surface plasmon polaritons (SPPs) was considered in [16-18] and in localized surface plasmons (LSPs) in [19]. Employing amplification for balancing losses in NIMs was first proposed by Pendry [20-21]. Pendry and co-workers have suggested “. . . a compensation for the losses by introducing optical gain media into the [NIM] lens design”. ([20], abstract)

Negative index materials are disclosed in WO 00/41270 to Pendry, et al., WO 01/71774 to Smith et al., and WO 03/044897 to Pendry et al., which discloses multilayered NIM lenses. U.S. Pat. No. 6,501,783 to Capasso et al. and US 2004/0155184 to Stockman et al. disclose the combination of gain material and surface plasmon materials in order to get stimulated emission of plasmon polaritons and/or photons.

### SUMMARY

The NIMCOL is based on the combined use of artificial magnetism obtained from elementary optical metal-dielectric resonators and stimulated emission from gain material inclusions to achieve the maximal enhancement of imaging resolution in NIM-based devices. The NIMCOL is built on a specially designed array of the sub-wavelength-scale metallic and dielectric elements that act as elementary optical nano-resonators manipulating local electromagnetic fields at nanometer scale areas and providing sufficiently negative local magnetic response. An elementary resonator typically consists of two shaped metal parts (e.g., solid particles, rods, strips) placed at a certain distance from each other, on the order of a few to tens of nanometers. Alternatively, the metallic parts are combined into a single element with a more complex shape (e.g., a hollow particle, hollow rod, hollow strip, or a film with random or periodic voids).

The NIMCOL can consist of an array of elementary resonators, as a first part of the metamaterial, and the gain material inclusions placed between the metallic parts of the resonators as a second part of the metamaterial, so that when the resonators and the inclusions are in close proximity to each other and additional emission is stimulated in the inclusions, and the absorptive losses in the metallic parts are compensated, while retaining negative magnetic response of the resonators. In contrast to Pendry, the NIMCOL is an effective material, where the gain inclusions that provide compensation for losses are in the same layer of material where the double resonant metallic structures are- located. Thus the material that we propose simultaneously provides n [symbol] >>0 and n¢<0 in one and the same layer.

The use of an assembly of metal-dielectric resonators placed on a substrate is preferable in some applications. In that case, the gain inclusions of the metamaterial can be distributed between the resonant elements in any desired and practical way. Provided that additional emission from the gain material is stimulated, the absorptive losses in each resonator are compensated, resulting in an adequate transmission through the metamaterial and enhanced resolution of a NIM-based optical device.

The NIMCOL-based devices also substantially differ from NSOM-type imaging schemes. In contrast to NSOM, they are initially much more promising in terms of imaging time and efficacy and can operate in far-field. The NIMCOL-based devices are also expected to have an image resolution capability that is by several orders of magnitude greater than the NSOM-type devices. Applications such as a loss compensated NIM waveguide, a NIM/PIM laser (overcompensation of losses) or a NIM switch containing gain materials are contemplated.

The refractive index (n=n¢+in [symbol] ) and therefore the resolution enhancement depends on the shape and arrangement of resonators, frequency and polarization of incident light, and the loss compensation energy supplied by gain inclusions. As a consequence, the approach provides sufficient flexibility in choosing working wavelength range for the NIM at a pre-fabrication stage and further adjustment of the transmission using controlled stimulated emission. The emission can be stimulated either optically or electrically, making NIMCOL-based devices even more attractive for optoelectronic integration.

The new composition of passive resonant metal-dielectric elements with active gain media results in a metamaterial with an effective negative refractive index and compensated losses. The composition overcomes the fundamental drawback of negative-index materials (NIMs) using plasmon resonant metallic elements in which absorptive losses reduce the overall performance of the devices based on such materials. To compensate for the losses, additional energy is supplied using stimulated emission from active elements made of a gain material. The composition is useful in NIM-based optical imaging and sensing devices with enhanced sub-wavelength resolution. The composition can be used with a lasing device to achieve an overcompensation of the loss in the NIM structures.

The core uses of the NIMCOLs are high-resolution optical devices for chemical/biological sensing, enhanced nano-fabrication techniques, and high-density optical data-storage devices. The NIMCOL-based devices could include i) nanophotonic waveguides, photon sources and switches, on-chip spectrophotometers and integrated nanophotonic systems, ii) flat super-lenses and their utilization for plasmonic nanolithography, nanoscale sensing and imaging; iii) beam-steering devices, and iv) reconfigurable and tunable/switchable optical, electro-optical, and nonlinear-optical multifunctional elements.

### BRIEF DESCRIPTION OF THE FIGURES

FIG. 1(a) shows double silver strips, separated by Al₂O₃. The strips are effectively infinitely long in y-direction and periodically repeated in x-direction. The H field is oriented in y-direction. Currents in the both strips are anti-parallel (see arrows in the magnified inset) if the H-field is polarized in y-direction.

FIG. 1(b) shows the real parts of the permittivity and permeability as simulated with FEMFD.

FIG. 2 shows the spectra of several optical constants of the structure shown in FIG. 1. Upper panel: Reflection R, transmission T, and absorption A spectra; Middle panel: real and imaginary part of the refractive index; Lower panel: real and imaginary part of the impedance. The vertical dashed line at 584 nm indicates a spectral region where the reflection is minimal, the transmission is high, the refractive index is n=−1.30+0.39i and the real part of the impedance is close to 1, indicating impedance matching to air.

FIG. 3(a) shows the same sample as in FIG. 1a, but with gain providing material in between the double silver strips. Air is assumed above and below the layer, and the layer is irradiated with a plane wave (584 nm) from above, H-field polarized along the y-direction.

FIG. 3(b) shows the transmission and reflection as a function of the gain. At g=12.10³ cm⁻¹ gain and losses cancel each other. Interestingly, the reflection shows also a minimum at g=12.10³ cm⁻¹.

FIG. 3(c,d) show the refractive index and impedance as a function of gain. n′≈−1.3, for all investigated gain levels.

FIG. 4(a) shows a NIM based on pairs of metal nanorods;

FIG. 4(b) shows a NIMCOL layer with gain beads;

FIG. 4(c) shows a NIMCOL structure with π-conjugated polymers

FIG. 5. is a sketch for basic nanophotoncs components: (a) photon source and (b) waveguide

FIG. 6. shows a NIMCOL switch.

### DESCRIPTION OF PREFERRED EMBODIMENTS

The refractive index (n=n¢+in [symbol] ) is the key parameter in the interaction of light with matter. While n′ has generally been considered to be positive, the condition n′<0 does not violate any fundamental physical law, and materials with negative index have some remarkable properties. For example, vectors [symbol] , [symbol] , and [symbol] form a left-handed system and such materials are synonymously called “left-handed” or negative-index materials (NIMs). No naturally existing NIM is known so far in the optical range and it is necessary to create artificial materials (metamaterials) in which the effective refractive index

$$( {n}_{eff}^{¢} )$$

is negative. A truly negative index

$${n}_{eff}^{¢} < 0$$

can only be achieved in metamaterials with structural dimensions far below the wavelength; for optical wavelengths such materials must be nano-crafted. A possible approach to create a NIM is to design a material where the effective isotropic properties (permittivity e=e¢+×ie [symbol] and permeability m=m¢+im [symbol] ) obey the equation e¢|m|+m¢|e|<0, which is always satisfied, if ε′<0 and μ′<0.

Conventional optical imaging has a spatial resolution of about a half-wavelength governed by the diffraction limit (i.e., approximately about 200-400 nm in visible range). The spatial resolution is even worse for IR imaging because of the longer wavelengths. Known resonant metal-dielectric NIMs could provide sub-wavelength resolution far beyond the diffraction limit, but absorptive losses in resonant elements of the NIMs are among the most important intrinsic limitations of their performance. The proposed NIMCOLs compensate for losses with amplification provided by the stimulated emission from gain inclusions and maintain the transmission at practical levels. We note that a loss-compensating approach should preserve the magnetic response of a given NIM.

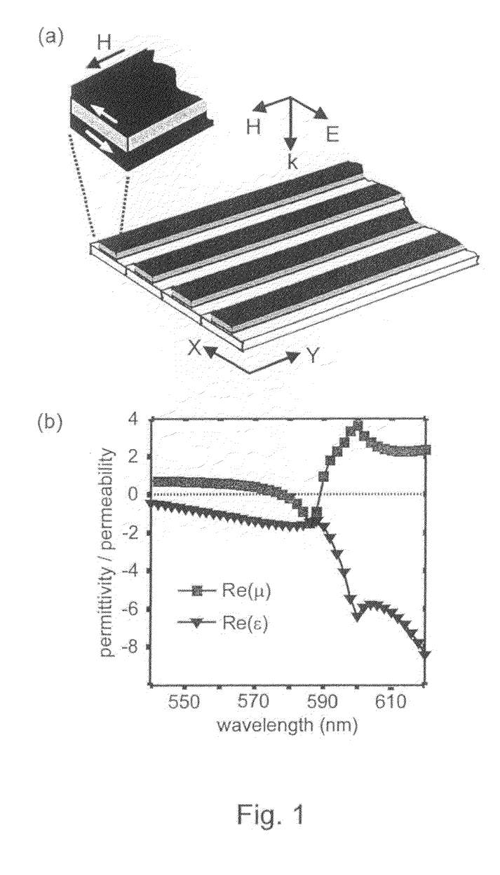

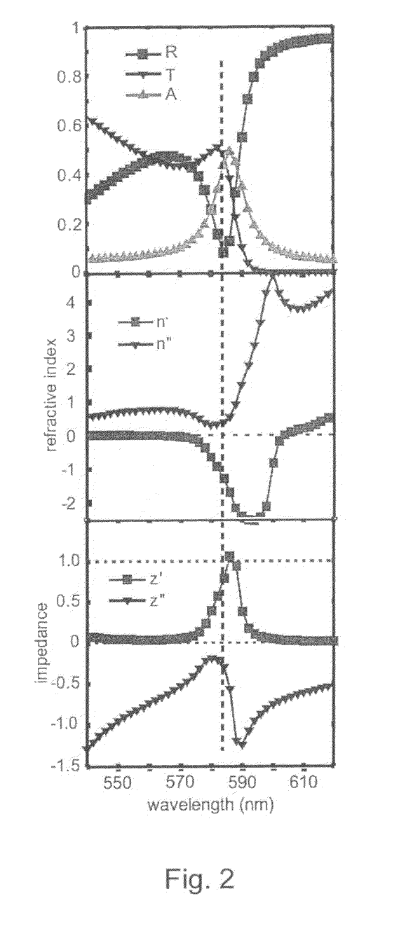

As discussed in [11-13], NIMs using plasmon resonant metallic elements have two distinct problems: high reflection and absorptive losses, both reducing the overall transmission through the metamaterial. The reflection is generally less difficult to handle; it can be suppressed by an optimized design with matched impedance. We show an example of optimized NIM where the conditions Z®1+0×i,n¢<−1, and |n [symbol] |<1 hold simultaneously for a visible wavelength. The NIM is arranged of coupled silver strips separated by a dielectric spacer (see FIGS. 1 and 2). For this NIM, the simulated transmission has a local maximum of 51 % at 582 nm. The impedance is matched quite well from 582 to 589 nm, i.e; Z′>0.5 and reaching 1 at 586 nm with |Z″|<0.5 in the range 570-585 nm. We have shown that a given design can be optimized to an impedance-matched NIM for the visible light. The transmission is limited to 50% almost solely due to absorption.

These absorptive losses (in terms of a large n [symbol] ) are the major difficulty, since the ohmic losses are generally large due to localized plasmon resonances. To overcome this difficulty we propose supplying energy from gain material in NIMs using stimulated emission.

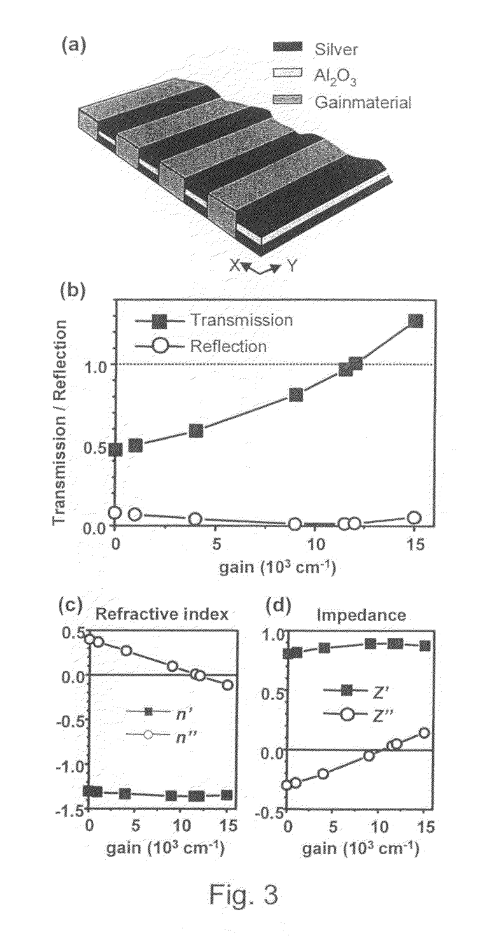

We simulated the same impedance-matched structure, but now we embedded a material that provides a fixed amount of gain between 0 and 15×10³ cm⁻¹ (see FIG. 3). We found that at a gain of 12×10³ cm⁻¹ the structure becomes transparent, while the real part of the refractive index n¢ is almost unaffected by the gain material. Moreover, the impedance which has already been matched quite well without the gain medium improves further when gain is applied, i.e. Z¢>>1 and Z [symbol] >>0 for_{g}=12×10⁻³cm⁻¹. The exact results for a gain of g=12×10⁻³cm⁻¹ are n¢=−1.355, n [symbol] =−0.008, Z¢=0.89, Z [symbol] =0.05, T=100.5%, and R=1.6%.

Thus, two key remedies are now available to overcome major obstacles that currently limit the development of optical negative-index materials (1) impedance matching designs are capable to suppress high reflectance, and (2) gain materials embedded in metallic nanostructures can fully compensate for absorptive losses while still retaining the negative refractive index. As a result of the above considerations, we conclude that it is realistic to compensate losses in NIMCOLs containing metal nanostructures by applying well-established techniques from semiconductor technology.

The major applications of the NIMCOLs are high-resolution optical devices for chemical/biological sensing, enhanced nano-fabrication techniques, and high-density optical data-storage devices. For example, new devices could include photonic waveguides, photon sources and switches, on-chip spectrophotometers, flat super-lenses and their utilization for plasmonic nanolithography, nanoscale sensing and imaging; beam-steering devices, and reconfigurable and tunable/switchable optical, electro-optical, and nonlinear-optical multifunctional elements.

The combined use of artificial magnetism obtained from the elementary optical metal-dielectric resonators and the stimulated emission from the gain material inclusions achieves the maximal enhancement of imaging resolution. The NIMCOL is built on a specially designed array of the sub-wavelength-scale metallic and dielectric elements that act as elementary optical nano-resonators manipulating local electromagnetic fields at nanometer scale areas and providing sufficiently negative local magnetic response. An elementary resonator typically consists of two shaped metal parts (e.g., solid particles, rods, strips) placed at a certain distance from each other, on the order of few to tens nanometers. Alternatively, the metallic parts are combined into a single element with a more complex shape (e.g., a hollow particle, hollow rod, hollow strip, or a film with random or periodic voids).

The NIMCOL consists of the array of elementary resonators, as the first part of the metamaterial, and the gain material inclusions placed between the metallic parts of the resonators as the second part of the metamaterial, so that when the resonators and the inclusions are in close proximity to each other and the additional emission is stimulated in the inclusions the absorptive losses in the metallic parts are compensated, while retaining the negative magnetic response of the resonators. Thus the material in our proposal simultaneously provides lm(n)≈0 and Re(n)<0 in one and the same layer.

The use of an arrangement of metal-dielectric resonators placed on a substrate is preferable in some applications. In that case, the gain inclusions of the metamaterial can be distributed between the resonant elements in any desired and practical way. Provided that the additional emission from the gain material is stimulated, the absorptive losses in each resonator are compensated, resulting in an adequate transmission through the metamaterial and enhanced resolution of a NIM-based optical device. This resolution enhancement can be greater than the resolution expected from a non-resonant multilayer structure, in addition it can be provided in the far-field regime.

The refractive index and therefore the resolution enhancement depend on the shape and arrangement of the resonators, the frequency and the polarization of the incident light, and the loss compensation supplied by the gain inclusions. As a consequence, the approach provides sufficient flexibility in choosing working wavelength range for the NIM at a pre-fabrication stage and further adjustment of the transmission using controlled stimulated emission. The emission can be stimulated either optically or electrically, making NIMCOL-based devices even more attractive for optoelectronic integration. Therefore, the radical solution to the problem of losses is to use gain media as host materials so that losses for surface plasmons (SPs) can be compensated by the gain in the host.

The losses in NIM lenses can be compensated in a layered structure, where lossy (lm(n)>0) layers of NIM (Re(n)<0) materials are interleaved with gain layers of positive refractive index (lm(n)<0, Re(n)>0). In contrast, we propose an effective material, where the gain inclusions that provide gain are in the same layer of material where the double resonant metallic structures are located. Thus, the material in our proposal simultaneously provides lm(n)<0 AND Re(n)<0 in one and the same layer.

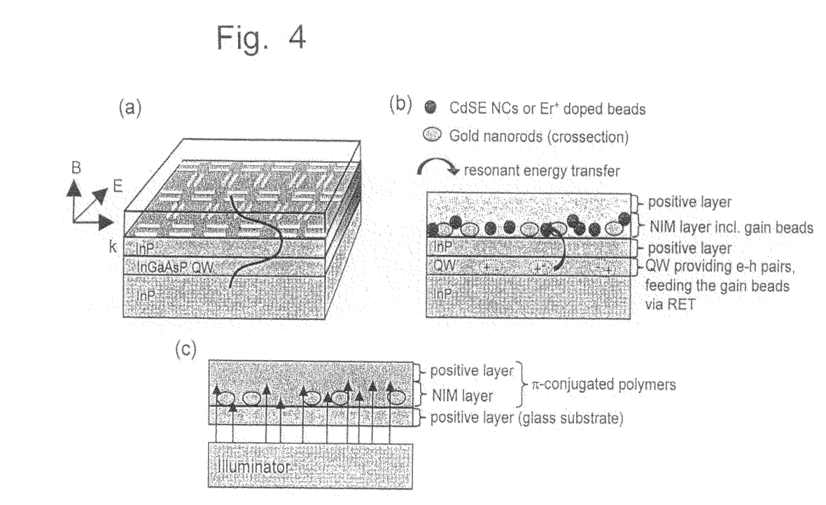

In addition to our simulations shown in FIG. 4 we also have done some rough calculations to estimate the gain which is necessary to compensate losses in NIM materials. The SP effective refractive index, nₚ=[ε_{d}εₘ/(ε_{d}+εₘ)]^{1/2}, for a typical case of εₘ″<<|εₘ′| and |εₘ′>>ε′_{d} predicts an absorption coefficient α=(4π/λ₀) and lm(nₚ)≈(2π/λ₀)εₘ′^{3/2}/(εₘ′)² [17, 18], where λ₀ is the vacuum wavelength (for simplicity, we assume here that |μ|˜1). By using known optical constants [25], we estimate the absorption as α=3×10² cm⁻¹ for silver and α≈10³ cm⁻¹ for gold at the telecommunication wavelength of 1.5 μm (we have used ε_{d}≈11.4 for InGaAsP). The required gain γ˜10³ cm⁻¹ needed to compensate losses in SPs is within the limits of the currently available semiconductor optical amplifiers (SOAs) [26, 27], such as InGaAsP-based media. We note that the estimated gain value γ_{SPP} decreases for smaller ε_{d} and thus the estimate above is an upper limit for lossless SPP propagation. Quantum dots embedded in glass or a polymer matrix can serve as gain media where a much lower γ is needed [28].

We also estimate the required gain to balance losses for LSPs in metal spheroids (rods) that can serve as NIMs. The polarizability (per unit volume) for such particles is given by β=(4π)⁻¹(εₘ-ε_{d})/[ε_{d}+p(εₘ-ε_{d})], where p is the depolarization factor (for a sphere, p=⅓). If the dielectric is a gain medium with ε_{d}″=−p/(1−p)εₘ″, then at the resonance both the real and imaginary parts in the denominator become zero, leading to extremely large local fields which are limited only by saturation effects [23]. For the gain coefficient in this case we find:

γ_{LSP}=(2π/λ₀)ε″_{d}/√|ε′_{d}|=(2π/λ₀)(Γ/wₚ)[p/(1−p)](ε₀+2ε′_{d})^{3/2}/√|ε′_{d}|˜10³ cm⁻¹[23] at λ=0.5 μm (we used the Drude formula εₘ=ε₀wₚ²/[w(w+iΓ)] and data of [25]). This gain is readily attainable not only in SOAs but also in dyes. Using a typical emission cross section of α=2.5×10⁻¹⁶ cm² for laser dyes [29], we arrive at a density of ρ=γ/σ=6×10¹⁸cm⁻³ or 10⁻² molar dye concentration. The required gain becomes smaller when the volume filling factor f by metal spheroids is smaller (e.g., for f˜10% γ_{LSP}˜10²cm⁻¹).

Shalaev and his collaborators have already verified in experiments that the LSP loss can be compensated by optical gain in dyes [22]. Other gain media such as Raman amplifiers and semiconductor nanocrystals (NCs) can also be used to compensate losses in NIMCOLs. The basic approach we can employ is similar to several kinds of solid state and organic semiconductor lasers where it has been shown successfully that sufficient gain can be provided so that devices containing metal layers or metal nanoparticles are capable of lasing. For instance, it has been shown by Klar et alii that an optically pumped organic laser comprising a metal-nanoparticle distributed feedback (DFB) grating needs only a marginally increased pumping threshold (compared to organic lasers with metal-free DFB gratings) to be operative [23]. In the case of infrared quantum cascade lasers (QCL), a wave guiding metallic layer was shown to be even beneficial for the laser power output [24]. This astonishing result is due to an increased overlap of the SPP-guided mode profile with the gain region (the quantum cascade structure, in this case), which offsets the increased losses (compared to a metal-free QCL) resulting from SPP excitation. The net effect is overall improved performance. In conclusion, based on the estimates above and the known results in semiconductor lasers, we are confident that losses in NIMs can be compensated in gain media.

NIMCOLs waveguides can overcome the diffraction limit and offer unparalleled methods for guiding light and developing novel nano/micro-photonic integrated circuits. Shalaev et a/. have recently demonstrated [11-13] the first ONIM based on parallel metal rods that has n=−0.3 at the telecommunication wavelength λ=1.5 μm with relatively low absorption (˜10%). The negative refraction magnitude can be increased significantly by optimizing the structure. In addition, various modifications to the original nanorod structure, such as the inverted system of parallel dielectric voids in metal films and parallel strips of metal in dielectric, exhibit a refractive index n′≈−2, as our simulations show. Nanorod-based structures, which have proven to be promising for ONIMs, can be developed into multi-layer and bulk materials. The fabrication method of e-beam lithography without a conductive substrate, which was used by the team, allows the repeated layering of ONIM layers to fabricate a thick 3D sample.

In this invention, we use the following concepts to provide gain to three-dimensional NIMCOL structures in accordance with the pathway provided by semiconductor lasing devices. FIG. 4a shows a NIMCOL structure consisting of pairs of gold (or silver) nanorods. The NIM structure is prepared on top of an InP layer using e-beam lithography and covered by a positive index polymer matching the index of InP. Therefore, the structure forms a waveguide containing a thin layer of negative material (gold or silver rods) and two layers of positive material (the upper InP layer and the covering polymer). Underneath the InP layer there is a quantum well (QW) made out of InGaAsP and an InP substrate. Electron-hole pairs will be pumped into the QW either electrically or optically. The guided wave mode leaks into the QW and thus is able to induce stimulated emission from the electron-hole pairs. In this way the QW will provide gain to the guided mode. While the final gain-supporting structure can contain additional layers of semi-conducting materials such as guiding, blocking and cladding layers and metal contacts as is typical of hetero-junction technology, they are omitted in FIG. 4a for clarity.

It is straightforward to provide gain as suggested in FIG. 4a. However, this concept may suffer from the fact that the gain area does not overlap with the majority volume of the guided mode. In the language of semiconductor laser technology, such a device provides a low confinement factor. Still, the solution of FIG. 4a may provide sufficient gain because, in contrast to semiconductor lasers, for the case of NIMCOL waveguides it is sufficient to compensate the loss and no “overcompensation” is needed. If however, the small confinement factor turns out to pose severe problems, alternative routes as depicted for example in FIG. 4b can be envisioned. In that case, the NIM layer contains not only metal nanorods, but also fluorescing dielectric species. These could be, for instance, semiconductor nanocrystals (NCs). They absorb over a wide range of short wavelengths and their fluorescence spectrum is Stokes-shifted compared to the absorption. Therefore, a NIM operating in the long wavelength edge of the NC fluorescence spectrum could gain energy without additional losses due to re-absorption. Erbium doped nanobeads could alternatively be used. Regardless of the material, we refer to these additional nanoparticles as “gain inclusions.”

The central advantage of mixing the gain inclusions into the NIM layer is that the confinement factor is maximal, i.e. the overlap of the guided mode profile and the gain region is maximal. The question remains as to how these gain beads can be efficiently excited. Here we want to follow the recently reported method of Ref. 37. Similar to FIG. 4a, the device is mounted on top of a QW layer. However, in this case the efficient resonant energy transfer (RET) from the electron hole pairs in the QW to the gain inclusions will pump the gain inclusions. The QW can be excited either by electrical or optical pumping. A third method of providing gain to the NIMCOL structure follows the ansatz of submerging the NIM structure with a π-conjugated polymer, similar to the previously mentioned organic laser with a gold grating DFB structure [23] (FIG. 4c). Here the polymer acts a gain-providing medium and can be pumped by an intense short wavelength illuminator underneath the sample. The illuminator transports the excitation energy on the basis of far-field radiation (in contrast to the approaches shown in FIGS. 4a and 4b), and it should also be useful to pump an entire three dimensional NIM structure above an illuminator. Instead of π-conjugated polymers, a solution or a solid solution of dye molecules may be used.

As possible application examples we show three core components needed for novel NIMCOL-based integrated nanophotonics: a source of photons, a low-loss photonic guide, and a switch. A new laser source can be based on two sub-wavelength slabs of NIM and a positive-index material (PIM) containing gain inclusions. Such a structure can act as a gain medium and, in parallel, as a feedback resonator because the flow of power is opposite in the NIM and PIM slabs. Our NIM waveguides can be guiding light on a sub-wavelength scale, reducing micro-photonic waveguides down to the nanoscale. Losses in such waveguides can be compensated by a gain media pumped either electrically (semiconductor optical amplifiers, SOAs) or optically (e.g., Raman amplifiers).

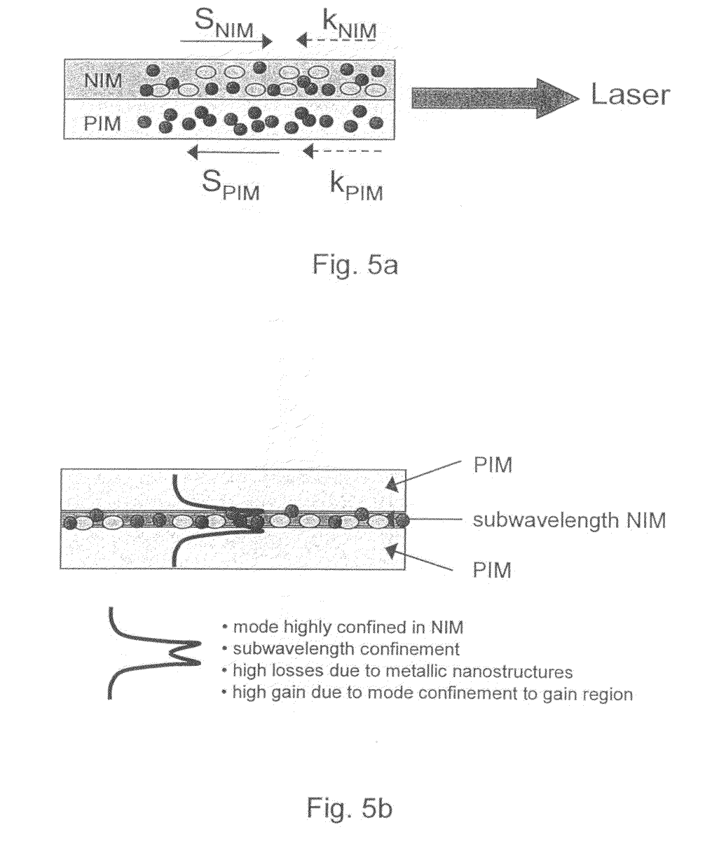

The proposed source of photons (laser) is shown in FIG. 5a. It consists of two parallel slabs of NIM and PIM. The NIM contains metal nanostructures and, additionally, gain inclusions. The PIM slab contains gain beads as well. The source of excitation for the gain beads is omitted for clarity, but may be implemented as shown in FIGS. 4b or 4c. It has been theoretically predicted by Engheta [25] that NIM and PIM slabs can act as a resonator because the flow of power, given by the Poynting vector S, is opposite in the two slabs. At the left and right boundaries, the local evanescent modes are excited and they induce a power flow in the opposite direction so that the Poynting vector at the boundary is “redirected” back into the other waveguide continuously, enabling the circulation of the electromagnetic energy within the system [25]. Such a backward coupler acts similarly to a periodically corrugated waveguide (grating reflector) but with the unusual feature that the “reflected” power is effectively flowing in a separate channel and is isolated from the “incident” power. In other words, the incident and reflected power flows are spatially localized in the two different waveguides. Together with the gain inclusions, this structure forms a laser and hence can act as a light source in an optical circuit.

It should be noted that this type of laser is conceptually different from the two common approaches to lasing. In a common laser, one needs a gain material and a feedback resonator which is formed either by a cavity or by a DFB grating. In both cases, the gain material and the resonator are clearly distinct elements. In the NIMCOL-PIM laser the resonant structure and the gain material cannot be distinguished. The refractive indices of the NIMCOL and PIM structures will change when the gain beads are pumped into inversion (as the absorption is bleached), and therefore the resonator and the gain media are inherently linked. This fact may open new, untapped opportunities in laser physics. In addition, the NIMCOL-PIM laser would also have the advantage of being sub-wavelength in size, which is not achievable in conventional lasers.

The second NIMCOL device to be discussed here is a waveguide (FIG. 5b). It has been shown that a NIM waveguide is capable of guiding light on a subwavelength scale. Unfortunately, the more the mode is confined, the more it overlaps with the lossy NIM structure. As such it has already been considered that subwavelength NIM waveguides may be of a limited use. Contrary to that assumption, we can compensate losses with gain provided by a material embedded in the NIM waveguide. In this case, the confinement not only leads to an increase in losses, but it also provides a better overlap of the mode with the gain beads. Hence the confinement factor increases, resulting in a larger gain (see FIG. 5b). As mentioned above, in the case of a QW laser comprising a flat metal plane as a waveguide (and mode concentrator), the increased confinement factor outweighs the negative effect of increased absorption [32]. Therefore we are confident that subwavelength waveguides accompanied by low losses can be achieved.

High losses in NIM structures can be compensated by gain in a hybrid NIMCOUwaveguide structure. Raman amplification in such Si waveguides can be very large [26-34]. High-contrast Si structures (ε_{Si}≈12 at 1.5 μm) can concentrate light in very small waveguides and, in parallel, reduce significantly the carrier lifetime and thus the pump depletion resulting from nonlinear absorption. Si waveguides for λ=1.5 μm with only 0.098 μm² cross section (220 nm×445 nm) and a 1 ns carrier lifetime has been recently demonstrated [29, 32]. Net gain of 0.8 dB has been observed in low-loss (3 dB/cm [30, 31]) submicron silicon-on-insulator (SOI) strip waveguides (photonic wires) for only 30 mW input power [33]. The incorporation of NIM structures that can provide up to 10 dB amplification with 1W pump power [34] on the top of a Si waveguide-based Raman amplifier would allow total compensation of losses. We note that in NIM guides supporting wave propagation in structures much smaller than the wavelength [25], the Raman amplification can be even larger. The hybrid structure, which combines the advantages of both worlds while minimizing the drawbacks, is also interesting for providing advanced optical functionalities to future on-chip optical interconnects. For example, strong coupling between an optical mode in a Si waveguide and a plasmon resonance in an NIM structure might result in unusual dispersion characteristics at resonance with much higher light confinement. This could allow one to explore ultra-compact optical devices with enhanced optical nonlinearities [29] for active on-chip control of light propagation.

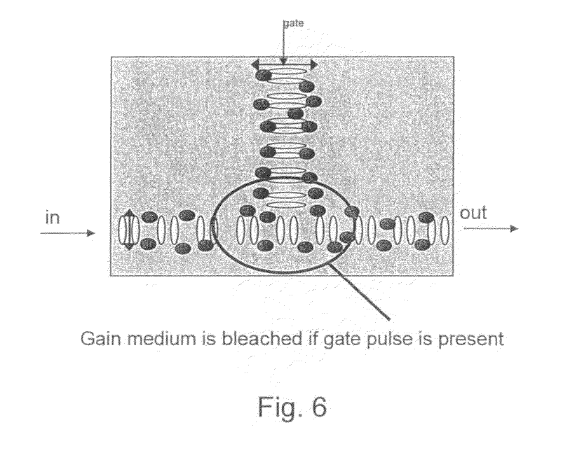

Another application example is an all-optical switch (FIG. 6). A NIM waveguide similar to that shown in FIG. 3b transfers optical information from left to right. From above, a second line called the gate transports a pulse that can switch off (close) the horizontal transduction line. This can be achieved by the effect known as stimulated emission depletion (STED), which was used by Klar et al [35] in high-end microscopy. Here we propose the use of STED in the following way: the off-gate pulse precedes the pulse flowing from “in” to “out” (from left to right) and thus it hits the junction slightly earlier than the horizontal pulse. The gate pulse would deplete the gain inclusions in the junction area and therefore the horizontal pulse impinging later in time suffers form losses which are not compensated by gain from the beads.

Thus, the foregoing description the embodiments shown in the Figures should be regarded as merely illustrative rather than limiting, and the following claims, including all equivalents, are intended to define the spirit and scope of this invention.

### REFERENCES

J. B. Pendry, A. J. Holden, D. J. Robbins, and W. J. Stewart, “Magnetism from Conductors and Enhanced Nonlinear Phenomena,” IEEE Transactions on Microwave Theory, 47, 2075-2084 (1999).

J. B. Pendry, A. J. Holden, W. J. Stewart, and I. Youngs, “Extremely Low Frequency Plasmons in Metallic Mesostructures,” Physical Review Letters, 76, 4773-4776 (1996).

R. A. Shelby, D. R. Smith, and S. Schultz, “Experimental verification of a Negative Index of Refraction,” Science 292, 77-79 (2001).

T. J. Yen, W. J. Padilla, N. Fang, D. C. Vier, D. R. Smith, J. B. Pendry, D. N. Basov, and X. Zhang, “Terahertz Magnetic Response from Artificial Materials,” Science 303, 1494-1496 (2004).

Z. Zhang, W. Fan, B. K. Minhas, A. Frauenglass, K. J. Malloy, and S. R. J. Brueck, “Midinfrared Resonant Magnetic Nanostructures Exhibiting a Negative Permeability,” Physical Review Letters, 94, 037402 (2005).

L. V. Panina, A. N. Grigorenko, and D. P. Makhnovskiy, “Optomagnetic composite medium with conducting nanoelements,” Physical Review B 66, 155411 (2002).

C. Enkrich, M. Wegener, F. Perez-Willard, S. Linden, J. Zhou, T. Koschny, and C. M. Soukoulis, “Optimizing the design parameters for split-ring resonators at telecommunication wavelengths,” presented at International Conference on Quantum Electronics and Laser Science (QELS), Baltimore (USA), 2005.

S. Linden, C. Enkrich, M. Wegener, J. Zhou, T. Koschny, and C. M. Soukoulis, “Magnetic Response of Metamaterials at 100 Terahertz,” Science, 306, 1351-1353 (2004).

A. N. Grigorenko, A. K. Geim, H. F. Gleeson, Y. Zhang, A. A. Firsov, I. Y. Khrushchev, and J. Petrovic, “Nanofabricated Media with negative permeability at visible frequencies,” Nature, vol. 438, pp. 335-338 (2005).

V. A. Podolskiy, A. K. Sarychev, and V. M. Shalaev, “Plasmon Modes in Metal Nanowires and Left-Handed Materials,” Journal of Nonlinear Optical Physics & Materials, vol. 11, pp. 65-74 (2002).

V. M. Shalaev, W. Cai, U. K. Chettiar, H. K. Yuan, A. K. Sarychev, V. P. Drachev, and A. V. Kildishev, “Negative index of refraction in optical metamaterials,” Optics Letters, vol. 30, pp. 3356-3358 (2005). This work was first posted in http://www.arxiv.org/abs/physics/0504091, Apr.13, 2005.

V. P. Drachev, W. Cai, U. Chettiar, H. K. Yuan, A. K. Sarychev, A. V. Kildishev, G. Klimeck, and V. M. Shalaev, “Experimental verification of an optical negative-index material,” Laser Physics Letters, v. 3, 49-55 (2006).

A. V. Kildishev, W. Cai, U. K. Chettiar, H. K. Yuan, A. K. Sarychev, V. P. Drachev, and V. M. Shalaev, “Negative Refractive Index in Optics of Metal-Dielectric Composites,” Journal of the Optical Society of America B, March (2006)

S. Zhang, W. Fan, N. C. Panoiu, K. J. Malloy, R. M. Osgood, and S. R. J. Brueck, “Experimental Demonstration of Near-infrared Negative-Index Metamaterials,” Physical Review Letters, vol. 95, pp.137404 (2005).

S. Zhang, W. Fan, K. J. Malloy, S. R. J. Brueck, N. C. Panoiu, and R. M. Osgood, “Demonstration of metal-dielectric negative-index metamaterials with improved performance at optical frequencies,” Journal of the Optical Society of America B, March (2006).

A. N. Sudarkin and P. A. Demkovich, “Excitation of surface electromagnetic waves on the boundary of a metal with an amplifying medium,” Sov. Phys.Tech. Phys. 34, 764-766 (1989).

M. P. Nezhad, K. Tetz, and Y. Fainman, “Gain-assisted propagation of surface plasmon polaritons on planar metallic waveguides,” Optics Express 12, 4072 (2004).

I. Avrutsky, “Surface plasmons at nanoscale relief gratings between a metal and a dielectric medium with optical gain,” Phys. Rev. B 70, 155416 (2004).

N. M. Lawandy, “Localized surface plasmon singularities in amplifying media,” AppI. Phys. Lett. 85, 540-542 (2004).

S. A. Ramakrishna and J. B. Pendry, “Removal of absorption and increase in resolution in a near-field lens via optical gain,” Phys. Rev. B. 67, 201101 (2003).

D. R. Smith et al, AppI. Phys. Lett., 82, 1506, (2003).

M. A. Noginov, G. Zhu, M. Bahoura, J. Adegoke, C. Small, S. N. Williams, C. Davison, V. P. Drachev and V. M. Shalaev, “Compensating surface plasmon losses in mixture of rhodamine 6G dye and Ag aggregate,” submitted to Phys. Rev. Lett. (2005).

J. Stehr, T. Klar, et al., “A low threshold polymer laser based on metallic nanoparticle gratings,” Advanced Materials 15, 1726 (2003).

A. Tredicucci, et al., Appl. Phys. Lett. 76, 2164-2166 (2000).

A. Alu, and N. Engheta, in Negative-refraction Metamaterials: Fundamental Principles and Applications, eds. G. V. Eleftheriades, & K. G.Balmain (Wiley, New York, 2005)

O. Boyraz and B. Jalali, “Demonstration of a silicon Raman laser,” Optics Express 12, 5269-5273 (2004).

O. Boyraz and B. Jalali, “Demonstration of directly modulated silicon Raman laser,” Optics Express 13, 796-800 (2005).

H. Rong, R. Jones, A. Liu, O. Cohen, D. Hak, A. Fang and M. Pannicia, “A continuous-wave Raman silicon laser.” Nature 433, 725 (2005).

J. Dadap, R. Espinola, R. Osgood, S. J. McNab, Y. A. Vlasov, “Raman Scattering in ultrasmall silicon waveguides,” Optics Letters 29, 2755 (2004).

S. J. McNab, N. Moll, and Y. A. Vlasov, “Ultra-low loss photonic integrated circuit with membrane-type photonic crystal waveguides,” Opt. Express 11, 2927-2939 (2003).

Y. A. Vlasov and S. J. McNab, “Losses in single-mode silicon-on-insulator strip waveguides and bends,” Opt. Express 12, 1622-1631 (2004).

R. L. Espinola, J. I. Dadap, R. M. Osgood, S. J. McNab, and Y. A. Vlasov, “Raman amplification in ultrasmall silicon-on-insulator wire waveguides,” Opt. Express 12, 3713-3718 (2004).

R. L. Espinola, J. I. Dadap, R. M. Osgood, S. J. McNab, and Y. A. Vlasov, “C-band wavelength conversion in silicon photonic wire waveguides”, Optics Express 13, 4341 (2005).

R. Claps, D. Dimitropoulos, Y. Han, B. Jalali, “Observation of Raman emission in silicon waveguides at 1.54 μm,” Optics Express 10, 1305-1313 (2002).

T. A. Klar, S. Jakobs, M. Dyba, A. Egner, and S. W. Hell, “Fluorescence microscopy with diffraction resolution limit broken by stimulated emission,” Proc. Natl. Acad. Sci. USA 97, 8206-8210 (2000).

1. A device comprising a negative index material with compensated losses using artificial magnetism obtained from elementary optical metal-dielectric resonators and stimulated emission from gain material inclusions to achieve enhanced imaging resolution.

2. The device of claim 1 comprising a nanophotonic waveguide.

3. The device of claim 1 comprising a photon source and switch.

4. The device of claim 1 comprising an on-chip spectrophotometer.

5. The device of claim 1 comprising a lens for use in a nanolithographic system.

6. The device of claim 1 comprising a lens for use in a nanoscale sensing system.

7. The device of claim 1 comprising a lens for use in a nanoscale imaging system.

8. The device of claim 1 comprising a beam steering device.

9. The device of claim 1 comprising a nonlinear optical multifunctional element.

10. A device comprising a negative index material with compensated losses, the negative index material including pairs of shaped metal parts spaced from each other by a distance of between about 3 and 30 nanometers, and a dielectric gain material situated between the shaped metal parts.

11. A device of claim 10 wherein the shape of the metal parts is selected from rods, solid particles, and strips.

12. The device of claim 10 wherein the metal forming the shaped metal parts is selected from the group consisting of silver and gold.

13. The device of claim 12 further comprising a separation material between the pairs of shaped metal parts comprising Al₂O₃.

14. The device of claim 12 wherein the shaped metal parts are sandwiched between an upper and lower layer, each layer comprising InP covered by a positive index polymer matching the index of InP.

15. The device of claim 14 wherein at least one of the upper and lower layer includes a quantum well comprising InGaAsP.

16. The device of claim 10 wherein the gain material comprises gain beads.

17. The device of claim 16 wherein the gain beads are Erbium doped.

18. The device of claim 10 comprising a π-conjugated polymer.

19. A device comprising a negative index material with compensated losses, the negative index material having a dielectric gain material containing at least one of: a hollow metal particle, a hollow metal rod, a hollow metal strip, or a metal film with random or periodic voids.
